(19) United States
(12) Patent Application Publication
(10) Pub. No.: US 2018/0197159 A1
(43) Pub. Date: Jul. 12, 2018

(54) MANAGING CHAIN-OF-OWNERSHIP FOR ART USING CRYPTOCURRENCY BLOCKCHAIN

(71) Applicant: Howard H. Sheerin, Scottsdale, AZ (US)

(72) Inventor: Howard H. Sheerin, Scottsdale, AZ (US)

(21) Appl. No.: 15/653,932

(22) Filed: Jul. 19, 2017

Related U.S. Application Data
(63) Continuation-in-part of application No. 15/405,039, filed on Jan. 12, 2017.

(51) Int. Cl. G06Q 20/12; H04L 9/06; G06Q 50/18; G06Q 20/38; G06F 21/16; G06Q 20/40

(52) U.S. Cl. CPC G06Q 20/1235; H04L 9/0637; G06Q 50/184; H04L 2209/60; G06F 21/16; G06Q 20/401; G06Q 20/3829

(57) ABSTRACT

A method of maintaining a chain-of-ownership for art pieces is disclosed. A first record is stored in a chain-of-ownership database which assigns a first item cryptocurrency address to a first item, and the Internet is used to transfer cryptocurrency from a first originator cryptocurrency address assigned to a first originator to the first item cryptocurrency address. A second record is stored in the chain-of-ownership database which assigns a second item cryptocurrency address to a second item, and the Internet is used to transfer cryptocurrency from the first originator cryptocurrency address to the second item cryptocurrency address. The first originator cryptocurrency address is transmitted over the Internet to a chain-of-ownership (COO) website, and the first originator cryptocurrency address is displayed in an originator website of the first originator.

### CROSS-REFERENCE TO RELATED APPLICATIONS

This application is a continuation-in-part of U.S. patent application Ser. No. 15/405,039 (Atty. Docket No. HS-004), filed on Jan. 12, 2017, entitled “MANAGING CHAIN-OF-OWNERSHIP FOR ART USING CRYPTOCURRENCY BLOCKCHAIN,” which is hereby incorporated by reference in its entirety.

### BACKGROUND

Artists have in the past issued paper certificates of authenticity for each art piece they create so as to increase the value of each art piece for subsequent buyers. When a second buyer is interested in purchasing an art piece from a first buyer, the first buyer may present the paper certificate of authentication with the art piece in order to prove their legal and legitimate ownership of the art piece. However, paper certificates may be easily forged which greatly diminishes the value and efficacy of this authentication system. There is, therefore, a need for a better system to authenticate art pieces that is not easily circumvented.

### BRIEF DESCRIPTION OF THE DRAWINGS

FIG. 1A shows a computer according to an embodiment for executing a flow diagram as shown, wherein a chain-of-ownership (COO) database is configured by transferring cryptocurrency from an artist cryptocurrency address to art-piece cryptocurrency addresses each assigned to an art piece created by the artist.

FIG. 1B shows an embodiment wherein the artist cryptocurrency address is a bitcoin address which is linked to first and second art-piece bitcoin addresses through a bitcoin blockchain, wherein each art-piece bitcoin address is further linked to a buyer bitcoin address thereby establishing a COO using the bitcoin blockchain.

FIG. 2 shows an embodiment wherein the COO database comprises multiple artist cryptocurrency addresses each assigned to a different artist, and each artist cryptocurrency address is linked to a number of art-piece cryptocurrency addresses each representing an art piece created by the artist.

FIG. 3A shows an embodiment wherein a list of art pieces for a particular artist is displayed (e.g., in alphabetical order) by a COO website including identifying information for the art piece (title, image, etc.) and the cryptocurrency address of the current owner of the piece as verified by the cryptocurrency blockchain.

FIG. 3B shows an embodiment wherein a COO for an art piece is generated by a COO website by querying the cryptocurrency blockchain, and then displayed together with the identifying information for the art piece (title, image, etc.).

FIGS. 4A and 4B show an embodiment wherein a link is displayed by a COO website to allow a user to edit an owner record of a COO cryptocurrency address.

FIG. 5 is a flow diagram according to an embodiment wherein a user of a COO website is allowed to edit an owner record for a COO cryptocurrency address after verifying ownership of the COO cryptocurrency address.

FIGS. 6A and 6B show an embodiment wherein a link is displayed by a COO website to allow a user to make an offer to purchase an art piece from a current owner.

FIG. 7 is a flow diagram according to an embodiment wherein when a buyer offers to buy an art piece from the current owner, the transaction is carried out using an escrow system of a COO website which includes updating the COO using the owner cryptocurrency address once the buyer approves of the art piece.

FIG. 8 is a flow diagram according to an embodiment for generating the COO for an art piece.

FIG. 9 shows an embodiment wherein a plurality of artist cryptocurrency addresses are linked to a master cryptocurrency address associated with a COO database.

FIG. 10 is a flow diagram according to an embodiment wherein when generating a COO for an art piece, an error is generated if the artist cryptocurrency address is not linked to the master cryptocurrency address of the COO database.

FIG. 11 shows an embodiment wherein the artist (originator) is a jeweler selling watches, wherein the originator cryptocurrency address is linked to a website of the originator.

FIG. 12 shows an embodiment wherein when a user selects the link assigned to the originator cryptocurrency address, a webpage of the originator website is displayed including the originator cryptocurrency address.

FIG. 13 shows an embodiment wherein when registering with a COO website an originator enters their originator cryptocurrency address as well as the webpage address of their website that comprises the originator cryptocurrency address.

FIG. 14A is a flow diagram according to an embodiment wherein an originator edits a webpage of their website so that the webpage will display their originator cryptocurrency address, and they transmit the address of the webpage to the COO website.

FIG. 14B is a flow diagram according to an embodiment wherein when an originator attempts to register with the COO website, the COO website verifies the webpage of the originator website comprises the originator cryptocurrency address before completing the registration process.

### DETAILED DESCRIPTION

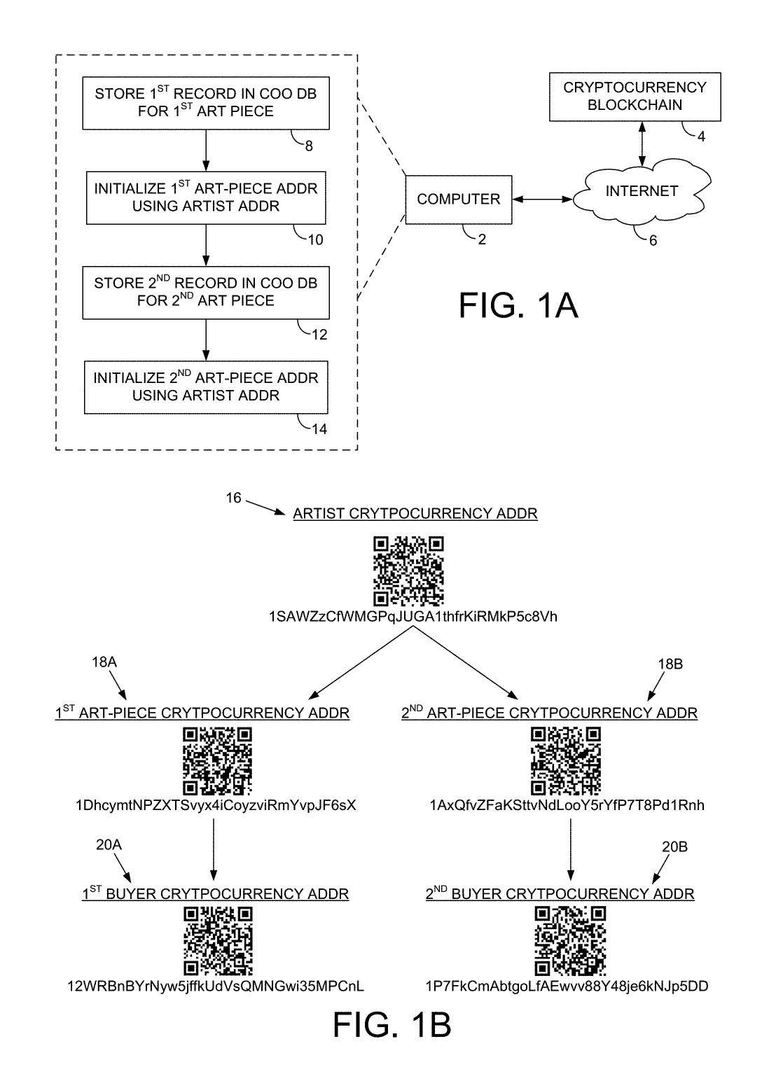

FIG. 1A shows a computer 2 according to an embodiment configured to execute the flow diagram as shown in order to manage a chain-of-ownership for art pieces by accessing a cryptocurrency blockchain 4 using an Internet 6. A first record which assigns a first art-piece cryptocurrency address to a first art piece is stored in a chain-of-ownership database (block 8), and the Internet is used to transfer cryptocurrency from a first artist cryptocurrency address to the first art-piece cryptocurrency address (block 10). A second record which assigns a second art-piece cryptocurrency address to a second art piece is stored in the chain-of-ownership database (block 12), and the Internet is used to transfer cryptocurrency from the first artist cryptocurrency address to the second art-piece cryptocurrency address (block 14).

Any suitable cryptocurrency may be employed in the embodiments disclosed herein, such as bitcoin or ethereum. The characteristics and implementation of a suitable cryptocurrency, such as bitcoin, are well known. In general, a cryptocurrency is a medium of exchange using cryptography to secure the transactions and to control the creation of additional units of the currency. A public database referred to as a blockchain is maintained by servers on the Internet in order to verify, facilitate, and record every transaction. The distributed nature of the blockchain over multiple nodes in the network together with a suitable form of timestamping (e.g., proof-of-work) ensures the security and authenticity of the database. Each unit of cryptocurrency (e.g., each bitcoin or fraction of bitcoin) is assigned to a public cryptocurrency address that is recorded in the blockchain, wherein the unit of currency may be transferred out of the public address (e.g., to another public address) using a private cryptocurrency key held by the current “owner” of the unit. In addition, the current balance of any particular public cryptocurrency address may be checked by any entity by executing a query of the blockchain database. In the embodiments described herein, these general characteristics of a cryptocurrency are exploited in order to manage a chain-of-ownership for art pieces.

Any suitable computer 2 may be employed in the embodiment of FIG. 1A, such as one or more server computers, one or more desktop computers, and/or one or more mobile computers (e.g., laptop, tablet, smartphone etc.). In one embodiment, the computer 2 may be a server computer for implementing an individual website that maintains a COO database for a single artist. For example, the flow diagram of FIG. 1B may be implemented within an individual website owned and managed by an artist, wherein the individual website may include other commonly implemented features, such as the sale of art pieces created by the artist. In another embodiment, the computer 2 of FIG. 1B may be a server computer for implementing a COO website that maintains a COO database for a number of artists. In one embodiment, each artist may create an account on the COO website in order to generate and configure a record within the COO database for each art piece created by the artist. In one embodiment, the COO website may include a public area accessible to public users, such as prospective buyers interested in viewing the chain-of-ownership for a particular art piece, or an actual buyer interested in verifying the chain-of-ownership has been updated after purchasing an art piece. In another embodiment described below, the COO website may enable a current owner of an art piece to edit an owner record within the COO database in order, for example, to list the art piece for sale. In yet another embodiment described below, the COO website may implement an escrow service to facilitate the transactions between sellers and buyers of the art pieces.

FIG. 1B shows an embodiment wherein an artist cryptocurrency address 16 may be a bitcoin address which is linked through a bitcoin blockchain to a first art-piece bitcoin addresses 18A assigned to a first art piece and linked to a second art-piece bitcoin address 18B representing a second art piece. In one embodiment, when an art piece is sold, the artist transfers ownership in the COO to the buyer by transferring cryptocurrency from the art-piece bitcoin address to a bitcoin address generated and owned by the buyer. This is illustrated in the example of FIG. 1B wherein the first art-piece bitcoin address 18A is further linked to a first buyer bitcoin address 20A thereby establishing a COO for the first art piece from the artist to the first buyer using the bitcoin blockchain. Similarly the second art-piece bitcoin address 18B is linked to a second buyer bitcoin address 20B thereby establishing a COO for the second art piece from the artist to the second buyer using the bitcoin blockchain. When the current owner intends to sell an art piece, the current owner transfers cryptocurrency from their bitcoin address to a bitcoin address of the new buyer, thereby extending the art piece COO to the new buyer.

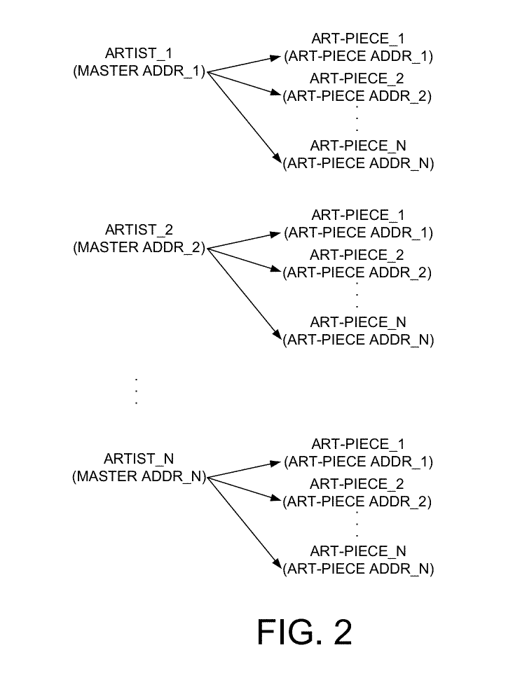

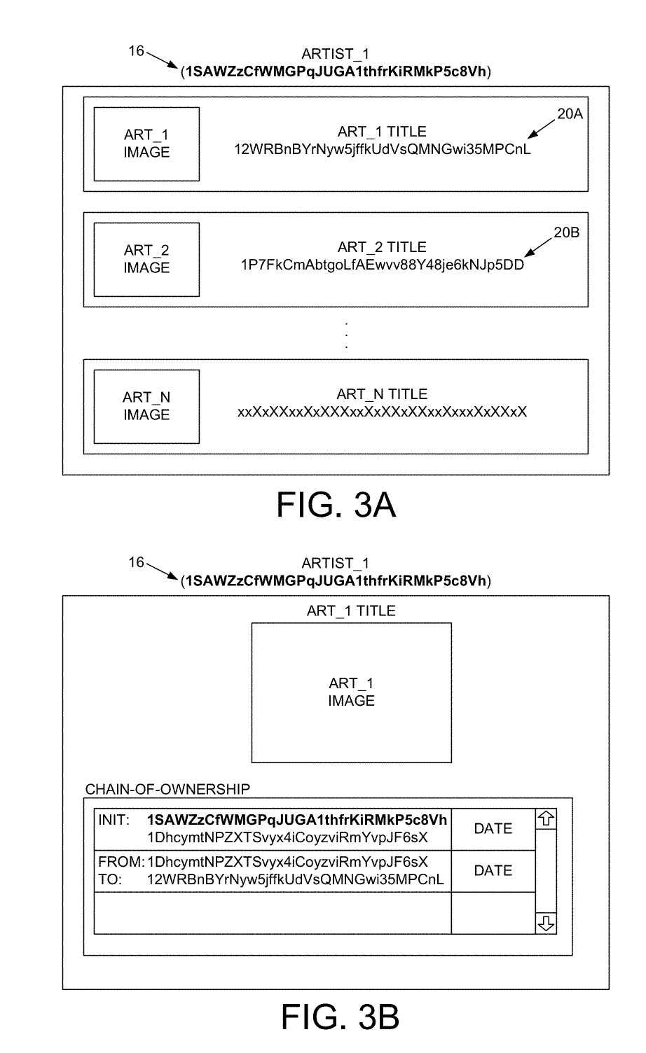

FIG. 2 shows an embodiment wherein the COO database may store records representing a number of artists each having their respective artist bitcoin address linked to a number of art pieces created by the artist. In one embodiment, a COO website for managing the COO database may display a list of all or some of the artists on a computer screen for inspection by a user of the COO website. For example in an embodiment shown in FIG. 3A, when a user selects ARTIST_1 from the list, the COO website may display a list of art pieces for ARTIST_1. In this embodiment, each art piece is displayed with an identifier (e.g., an image and/or title) together with the current owner bitcoin address (e.g., 20A, 20B). The artist bitcoin address 16 may also be displayed so that the user of the COO website may verify they are viewing the legitimate art piece COO for the selected artist. In one embodiment, a user of the COO website may verify the artist bitcoin address 16 is correct by referring to an independent source, such as an individual website owned and managed by the artist, or an independent database maintained by an independent registry website.

FIG. 3B shows an example when a user selects ART_1 from the list shown in FIG. 3A. The title together with a larger image is displayed which enables the user to verify they are viewing the correct art piece. The COO for the art piece is also displayed, including in this embodiment the date of each transfer, wherein the last entry in the COO list represents the current owner of the art piece. In other embodiments, any suitable information may be displayed for each entry in the COO list, such as a price paid for the art piece in connection with each transfer, or information about either or both the seller and the buyer. In one embodiment, each bitcoin address shown in the COO list may be linked to a record representing the owner of the bitcoin address. When a user selects a bitcoin address in the COO list, information associated with the owner of the bitcoin address may be displayed, such as their name, telephone number, email address, etc. This embodiment may help further verify the COO for a prospective buyer of an art piece by enabling the buyer to verify the identity of the seller as the legitimate owner of the art piece.

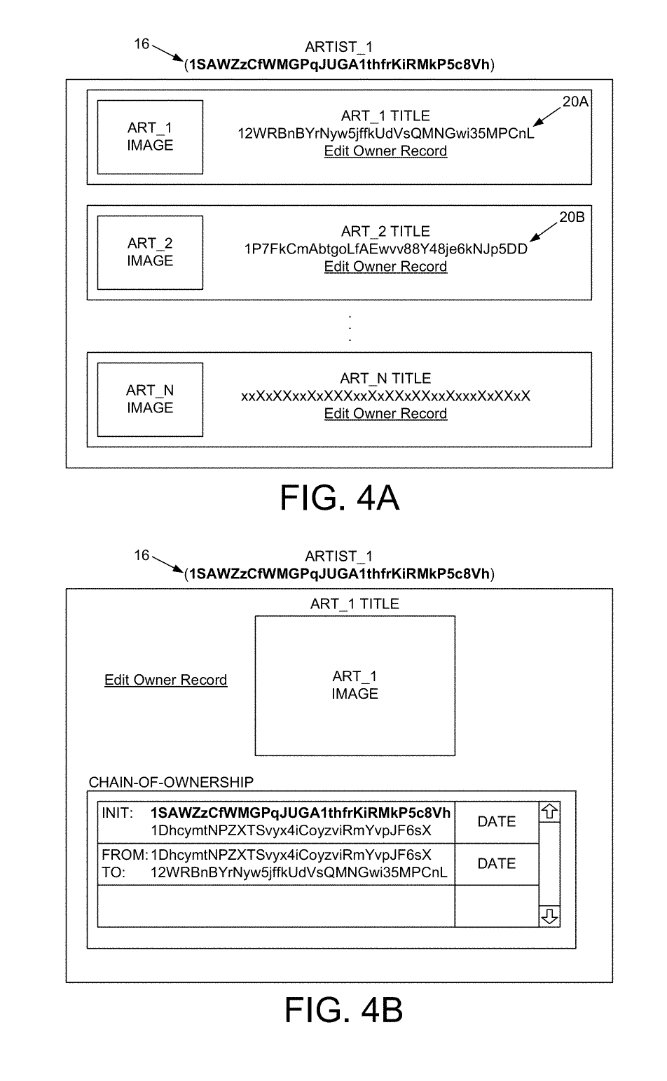

FIGS. 4A and 4B show an embodiment wherein when a COO bitcoin address for an art piece is displayed, the website enables a user to edit an owner record associated with the COO bitcoin address. In the example of FIGS. 4A and 4B, an “Edit Owner Record” link is displayed together with the COO bitcoin address. In another embodiment, the COO bitcoin address itself may be a link which when selected enables a user to edit an owner record. Any suitable information may be edited within the owner record, such as owner name, owner contact information, owner website, etc. In one embodiment, the owner record may include a sale price for the art piece represented by the COO bitcoin address, wherein if a sale price is specified, the sale price may be displayed in the COO website, for example, in the list of art pieces such as shown in FIG. 4A and/or when the COO list for the art piece is displayed such as shown in FIG. 4B.

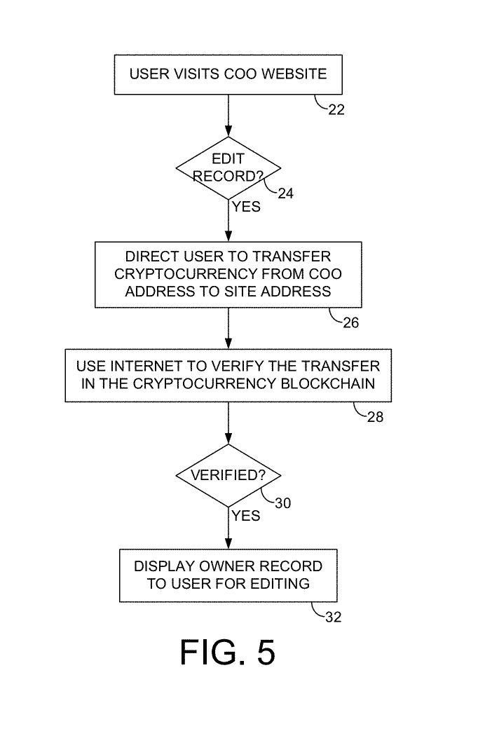

In one embodiment, the COO website processes a COO bitcoin address in order to verify a user is the legitimate owner of the COO bitcoin address before allowing the user to edit the owner record. An example of this embodiment is shown in the flow diagram of FIG. 5 wherein when a user visits the COO website (block 22) and requests to edit an owner record for a COO bitcoin address (block 24), the COO website directs the user to transfer bitcoin from the COO bitcoin address to a bitcoin address controlled by the COO website (block 26). The COO website then queries the bitcoin blockchain (block 28) in order to verify the transfer. The COO website may query the bitcoin blockchain at block 28 in any suitable manner, such as with the well-known blockchain explorer website www.blockchain.info. If the transfer is verified (block 30), the COO website displays the COO bitcoin address owner record for editing by the user (block 32).

In one embodiment, a user may register with the COO website, including to populate a user record with information about the user (e.g., contact information). In this manner when the user submits a request to edit an owner record for a COO bitcoin address, and the user is verified as described above, the COO website may automatically populate at least some fields of the owner record using the user record. In one embodiment, the user record may include a list of COO bitcoin addresses owned by the user and a corresponding art piece assigned to each COO bitcoin address if it is the last COO bitcoin address in the COO list associated with an art piece. In one embodiment, the user associated with a user record may be an artist, an owner of an art gallery, an art collector, etc. In one embodiment, the user record of the COO website may be used to display a store front for the user, for example, wherein the art pieces owned by the user as well as a sale price for each art piece may be displayed to prospective buyers.

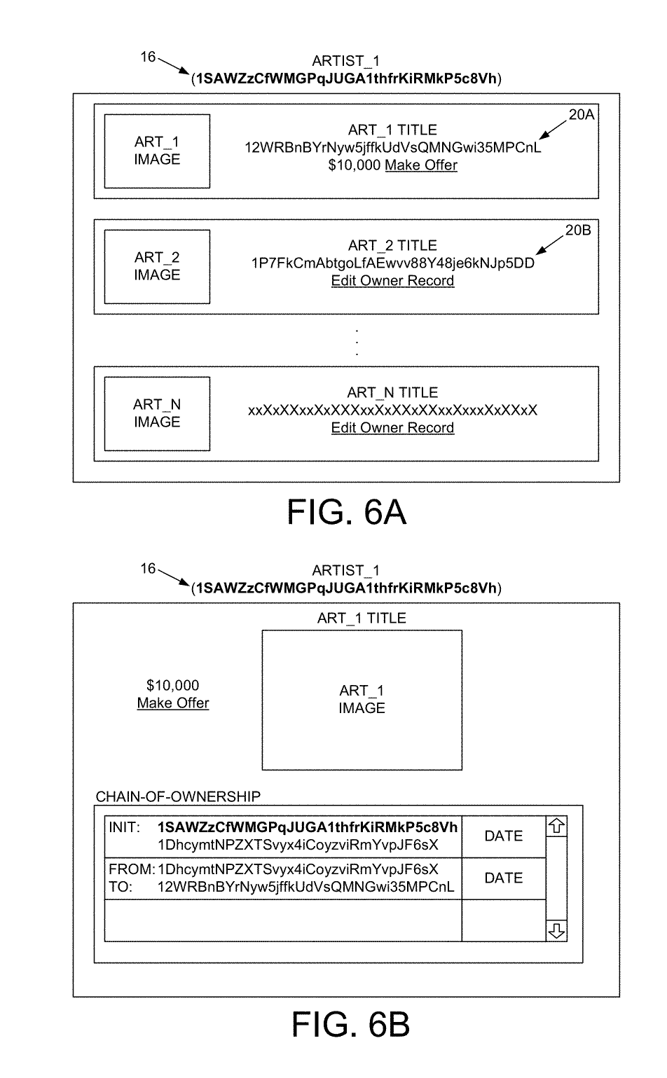

FIGS. 6A and 6B show an embodiment wherein when displaying an art piece in the COO website (e.g., when displaying an artist list or a specific art piece), a sale price for the art piece may be displayed together with a link to make an offer (or the sale price may be the link). When a user of the COO website clicks on an offer link, the COO website displays a page to enable the user to submit an offer price which the COO website then forwards to the owner of the art piece. In one embodiment, the offer for sale and/or offer to purchase may be communicated anonymously using the COO website. That is, in one embodiment one or both the seller or the buyer may wish to remain anonymous for privacy and/or security reasons.

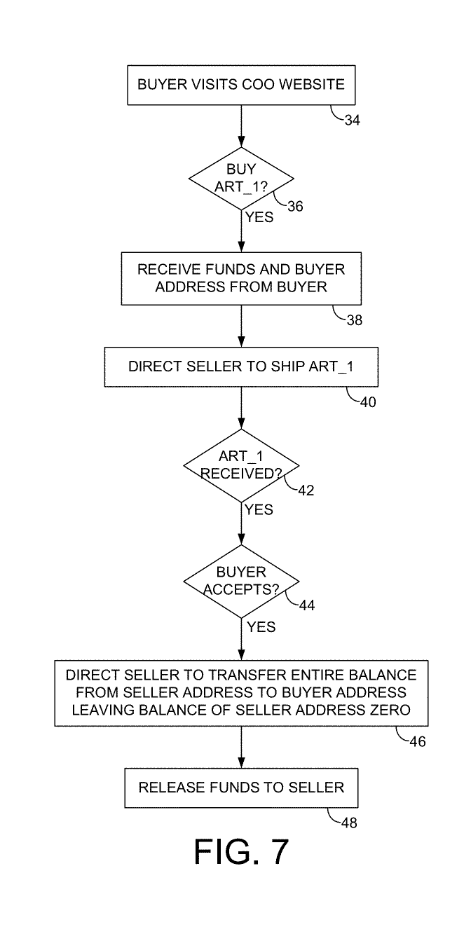

In one embodiment, the COO website may act as an intermediary to facilitate the purchase of an art piece so as to provide any suitable service, such as the anonymous transfer of an art piece. In one embodiment, the COO website may function as an escrow entity wherein the funds for purchasing an art piece may be held by the COO website until the buyer receives and approves of the art piece. An example of this embodiment is shown in the flow diagram of FIG. 7, wherein when a user visits the COO website (or logs into the website) (block 34) and submits an offer to buy a piece of art which is accepted by the seller (block 36), the buyer is directed to send the funds and their bitcoin address to the COO website for safekeeping in an escrow account (block 38). When the COO website receives the funds and bitcoin address from the buyer, the COO website directs the seller to ship the art piece to the buyer (block 40) preferably using a shipping service with a tracking function. When the buyer receives the art piece (block 42), the buyer inspects the art piece to verify it's the correct art piece. After the buyer notifies the COO website that the art piece is acceptable (block 44), the COO website directs the seller to transfer the entire balance of the COO bitcoin address (seller address) to the buyer's bitcoin address (block 46), thereby transferring ownership of the art piece to the buyer as reflected in the COO for the art piece. After the COO website verifies the transfer by querying the bitcoin blockchain (e.g., using www.blockchain.info), the COO website releases the funds to the seller (block 48).

In one embodiment, a transfer of ownership as reflected by the COO only occurs when the entire balance is transferred from a seller bitcoin address to a buyer bitcoin address. In this manner, the holder of an art piece can prove to a prospective buyer that they are the true owner of the art piece by transferring a small amount of cryptocurrency from the owner bitcoin address to another bitcoin address. For example, a seller may transfer a small amount from the owner bitcoin address to a prospective buyer's bitcoin address so that the buyer can verify that the seller possesses the owner bitcoin address for the art piece. In another embodiment, the seller may make a small transfer from the owner bitcoin address back to the owner bitcoin address so as to retain the cryptocurrency (minus the miner fee). Regardless as to where the cryptocurrency is transferred, the transfer itself (which reduces the balance of the owner bitcoin address) proves that the seller possesses the owner bitcoin address and therefore is the true owner of the art piece. In this manner, the buyer is reassured of the validity of the transaction before transferring funds (e.g., to the seller or to an escrow account). Once the art piece is received by the buyer and the funds received by the seller, the seller may then transfer the entire balance from the owner bitcoin address (seller bitcoin address) to the buyer's bitcoin address so that the transfer is reflected in the COO (including on the COO website). Once an art-piece bitcoin address has been reduced to zero, any subsequent transactions (in or out) involving the bitcoin address will not affect the COO. For example, when the COO website generates the COO list for an art piece such as shown in FIG. 3B, the COO website will ignore any transactions associated with a bitcoin address after encountering a transaction that reduces the balance to zero. That is, in one embodiment a transfer of ownership occurs in the transaction history of a bitcoin address when there is a transfer of the entire balance to a different bitcoin address which then becomes the next owner bitcoin address within the COO.

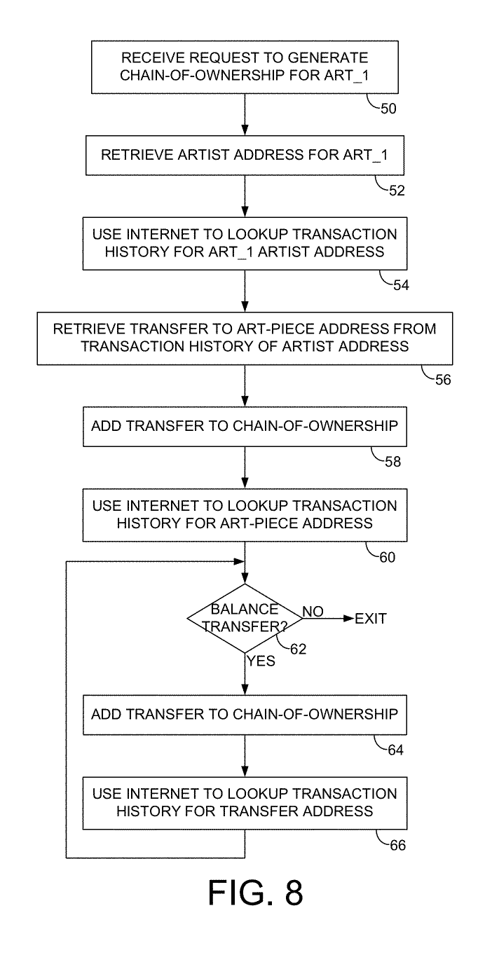

FIG. 8 is a flow diagram which illustrates an embodiment for generating the transaction chain representing the COO list for a particular art piece (ART_1) such as shown in FIG. 3B. When a request is received (e.g., by the COO website) to generate the COO for ART_1 (block 50), the artist bitcoin address that created ART_1 is retrieved from the COO database (block 52). The Internet is used to lookup the transaction history for the artist bitcoin address (block 54) to locate the balance transfer from the artist bitcoin address to the art-piece bitcoin address (block 56). The art-piece bitcoin address is added to the COO list (block 58), and the Internet is used to lookup the transaction history for the art-piece bitcoin address (block 60) to determine whether there is a subsequent balance transfer to a buyer bitcoin address. If there is a balance transfer to a buyer bitcoin address (block 62), the buyer bitcoin address is added to the COO list (block 64), and the Internet is used to lookup the transaction history for the buyer bitcoin address (block 66) to determine whether there is a subsequent balance transfer to a next buyer bitcoin address. The flow diagram is repeated from block 62 until the end of the COO is reached; that is, until a COO bitcoin address in the transaction chain is located that does not have a balance transfer in the transaction history. Any suitable technique may be employed to lookup the transaction history of a bitcoin address in the bitcoin blockchain, such as by using the well-known blockchain explorer website www.blockchain.info.

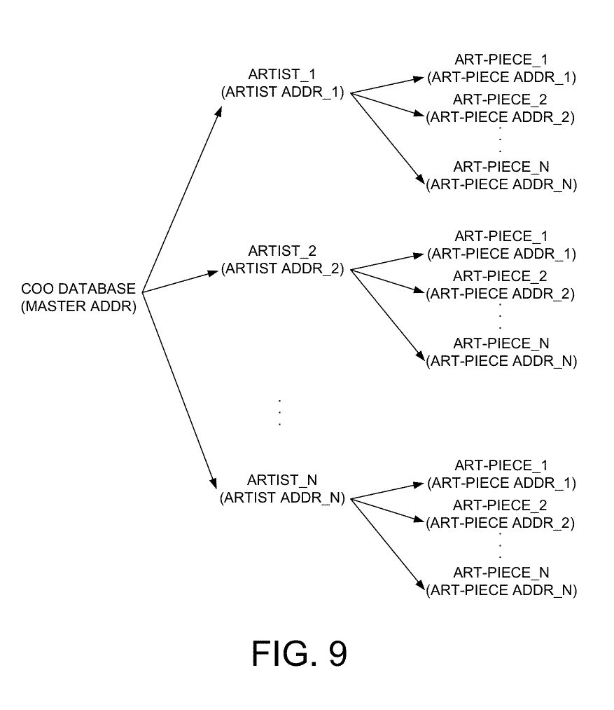

FIG. 9 shows an embodiment wherein the COO database may comprise a master cryptocurrency address that is linked to a number of artist cryptocurrency addresses. In one embodiment, the master cryptocurrency address may be used by a COO website to verify that an artist cryptocurrency address is valid; that is, in one embodiment an artist cryptocurrency address may be considered valid only if it is linked to the master cryptocurrency address of the COO database. In one embodiment, when an artist registers with the COO website the artist may be verified using any suitable technique before assigning an artist cryptocurrency address to the artist. For example, a website entered by the artist when registering may be evaluated to verify other information entered by the artist, such as their name, email address, phone number, etc. Evaluating an artist website may be performed manually by a site administrator of the COO website, or it may be automated by the COO website using any suitable computer program. The artist cryptocurrency address may be linked to the master cryptocurrency address by executing a transfer of cryptocurrency from the master cryptocurrency address to the artist cryptocurrency address. In one embodiment, a site administrator of the COO website may perform the transfer from the master cryptocurrency address to the artist cryptocurrency address, and in another embodiment, the transfer may be automated by the COO website using any suitable computer program.

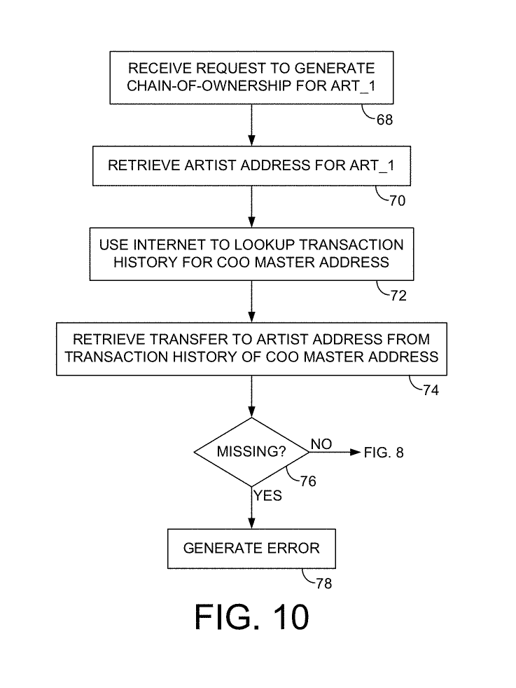

FIG. 10 is a flow diagram which illustrates an embodiment for generating the transaction chain representing the COO list for a particular art piece (ART_1) such as shown in FIG. 3B when the artist cryptocurrency addresses are linked to a master cryptocurrency address. When a request is received (e.g., by the COO website) to generate the COO for ART_1 (block 68), the artist bitcoin address that created ART_1 is retrieved from the COO database (block 70). The Internet is used to lookup the transaction history for the master cryptocurrency address of the COO database (block 72), and the transaction history is evaluated to locate the artist cryptocurrency address (block 74). If the artist cryptocurrency address is located (block 76), then the COO list is generated for the art piece by, for example, executing the flow diagram of FIG. 8 as described above. If the artist cryptocurrency address is not linked to the master cryptocurrency address through a transfer transaction, then an error is generated (block 78). For example, the COO website may display an error message to the user and/or notify a site administrator of the anomaly. In one embodiment, the master cryptocurrency address may help verify the integrity of the COO database. For example, if the COO database is hacked to include an illegitimate artist cryptocurrency address, the unauthorized modification to the COO database may be detected since hacking the COO database will not modify the cryptocurrency blockchain without executing a transfer from the master cryptocurrency address to the illegitimate artist cryptocurrency address.

The above-described embodiments may be implemented by any suitable originator of any suitable item. For example, in addition to an originator being an artist that creates an art piece (e.g., a painting), in other embodiments an originator may be an art dealer that receives an art piece from an artist, or a reseller of an art piece. Accordingly, the above embodiments may be considered as instantiating a chain-of-ownership by transferring cryptocurrency from an originator cryptocurrency address assigned to an originator (e.g., artist, manufacturer, dealer, reseller, etc.) to an item cryptocurrency address. In addition, the item cryptocurrency address may be assigned to any suitable item, such as any suitable art piece (e.g., painting, sculpture, music composition, literature, etc.) or any suitable collectable (e.g., jewelry, watches, coins, memorabilia, etc.), or any other valuable item for which it may be desirable to track the chain-of-ownership.

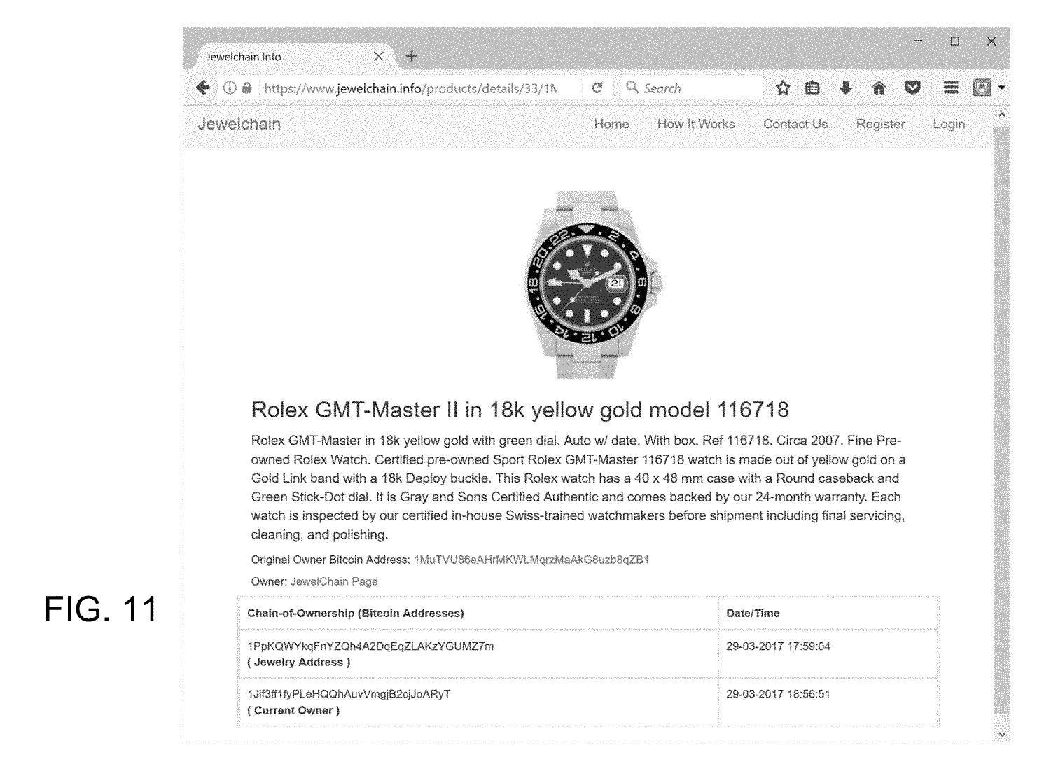

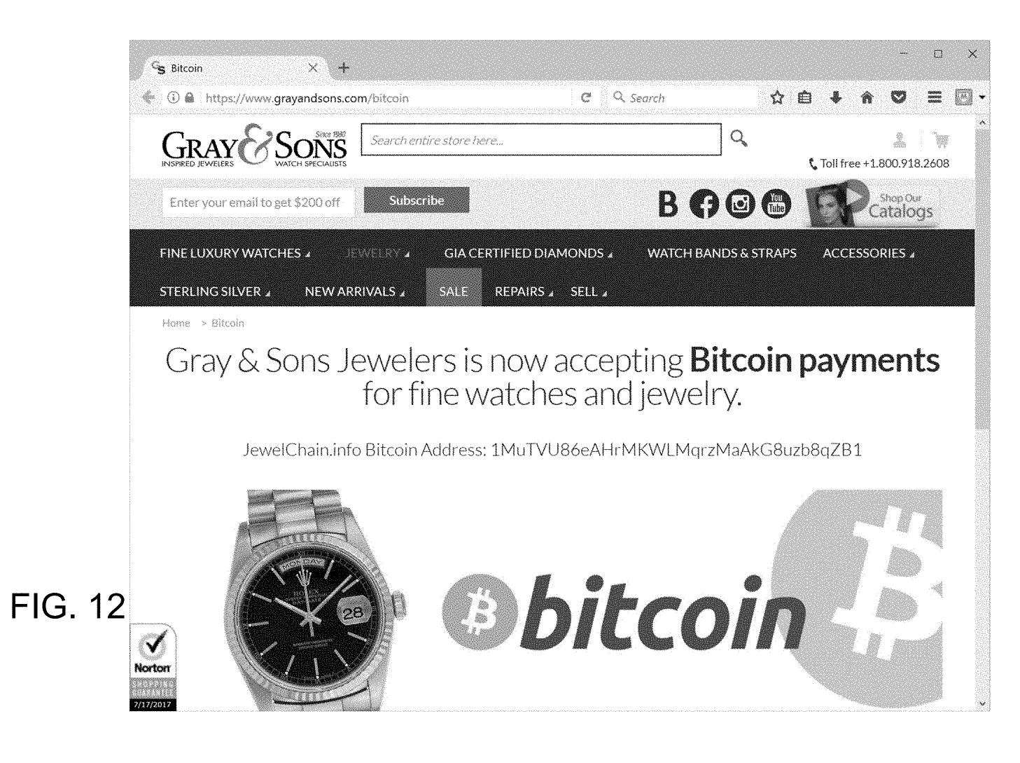

FIG. 11 shows a webpage of a COO website (www.jewelchain.info) according to an embodiment wherein the valuable item for which the chain-of-ownership is tracked is a watch, and the originator that registered the watch with the COO website is a jeweler. The webpage displays an image of the watch, a description of the watch, and a chain-of-ownership which in this embodiment is in bitcoin addresses. The webpage also displays the originator cryptocurrency address which in this example is shown as an Original Owner Bitcoin Address:
1MuTVU86eAHrMKWLMqrzMaAkG8uzb8qZB1
   In one embodiment, the originator cryptocurrency address is linked to a webpage of a website of the originator. When a user viewing the webpage of the COO website selects the link associated with the originator cryptocurrency address, the webpage of the originator website is displayed. FIG. 12 shows an example of a webpage of an originator website that may be displayed, wherein in this embodiment the webpage displays the originator cryptocurrency address as:
JewelChain.info Bitcoin Address: 1MuTVU86eAHrMKWLMqrzMaAkG8uzb8qZB1
   Notice that the originator cryptocurrency address displayed in the originator's website shown in FIG. 12 is the same as that displayed in the COO website shown in FIG. 11. This allows the user to verify that the originator's website has been edited to include the originator cryptocurrency address that is shown in the COO website. This linking of the two websites helps prove the legitimacy of the chain-of-ownership displayed in the COO website since the originator is typically the only entity with the ability to edit their website so as to display the originator cryptocurrency address. In other words, a hacker would have to hack both the COO website and the originator website in order to successfully modify the chain-of-ownership of an item being tracked by the COO website. If a hacker were to successfully hack only the COO website, a user of the COO website could detect the hack by comparing the originator cryptocurrency address displayed in the originator website to the originator cryptocurrency address displayed in the COO website.

Since only the originator controls the private cryptocurrency key corresponding to their originator cryptocurrency address, only the originator can instantiate a new chain-of-ownership to track a new item. Accordingly, a user can verify any particular chain-of-ownership is legitimate by verifying the chain of cryptocurrency transactions links back to the originator cryptocurrency address displayed in the originator website. For example, why viewing the chain-of-ownership in the COO website such as shown in FIG. 11, a user could click on the originator cryptocurrency address (Original Owner Bitcoin Address in this example) to display the webpage of the originator website (FIG. 12). The user could then verify the originator cryptocurrency address is the same on both websites, thereby verifying the chain-of-ownership displayed in the COO website links back to the originator cryptocurrency address displayed in the originator website.

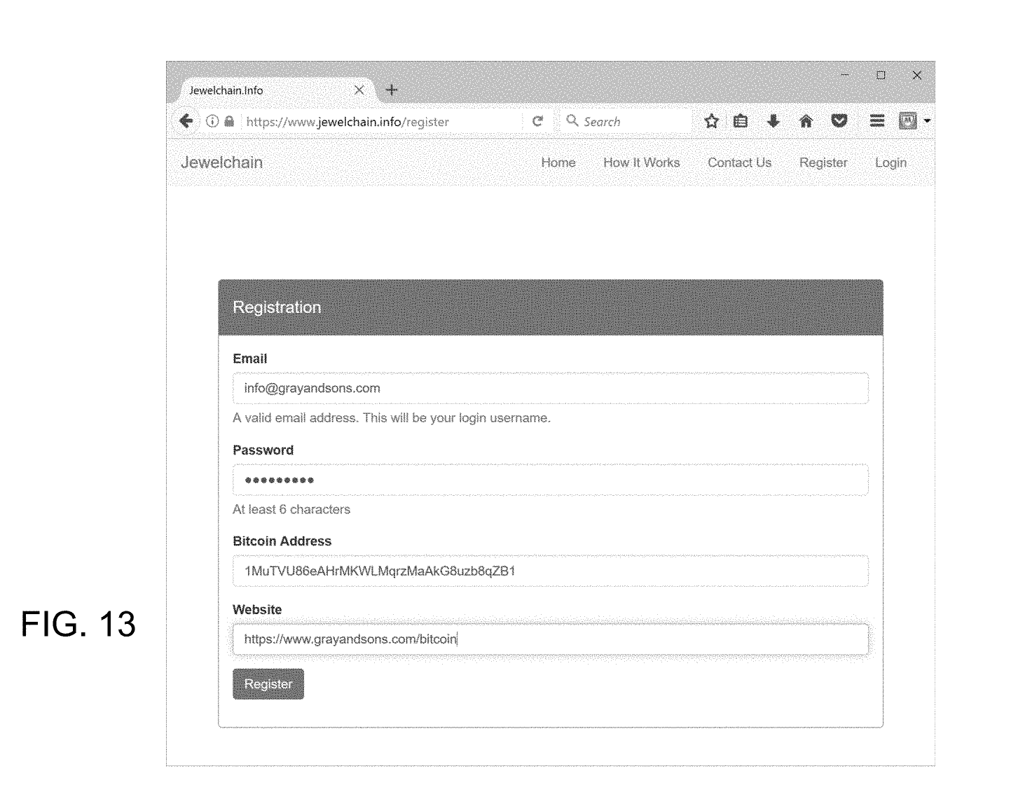

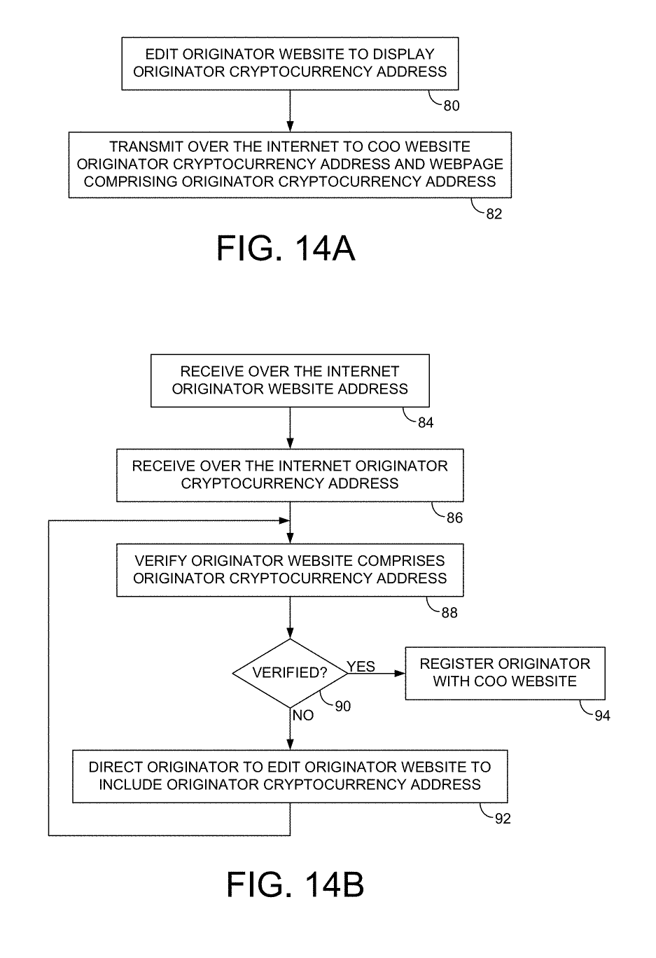

FIG. 13 shows a registration webpage of a COO website according to an embodiment for registering a new originator which is understood with reference to FIG. 14A. The originator (e.g., an artist or jeweler) edits a webpage of their originator website (FIG. 14A: block 80) to display their originator cryptocurrency address such as shown in the example of FIG. 12. The originator visits the webpage for registering with the COO website such as shown in FIG. 13, where in this embodiment the originator enters an email address, a password, and the originator cryptocurrency address (bitcoin address in this example). The originator also enters a webpage address of the originator website that comprises the originator cryptocurrency address, where in this example the webpage address is:
https://www.grayandsons.com/bitcoin
   When the originator selects the “Register” button on the registration webpage, the registration information is transmitted over the Internet to the COO website, including the originator cryptocurrency address and the webpage address of the originator website comprising the originator cryptocurrency address (FIG. 14A: block 82).

FIG. 14B is a flow diagram according to an embodiment that is executed by a computer hosting the COO website that maintains a COO database for maintaining the originators and corresponding chain-of-ownership of their registered items. In this embodiment, the computer receives over the Internet the webpage address of the originator website that comprises the originator cryptocurrency address (block 84) and receives over the Internet the originator cryptocurrency address (block 86). The computer verifies the webpage of the originator website comprises the originator cryptocurrency address (block 88), for example, by comparing the originator cryptocurrency address to the content of the webpage. If the verification fails (block 90), the computer directs the originator to edit the webpage of the originator website to include the originator cryptocurrency address (block 92). When the verification passes (block 90), the computer registers the originator with the COO website (block 94) by creating a new record in the COO database representing the originator.

The above-described embodiments may be implemented using any suitable computer system, including one or more server computers, one or more personal computers, one or more cell phones, etc. In one embodiment, the flow diagrams shown in the figures may be implemented using a computer system comprising a microprocessor configured to execute steps of a computer program. In one embodiment, the steps of the computer program may be stored on a suitable, non-transient computer readable storage medium, such as a disk drive or a flash memory. In some embodiments, at least some blocks of the flow diagrams may be implemented using the Internet, and in other embodiments at least some blocks of the flow diagrams may be implemented using a cellular network. Other embodiments may employ both the Internet as well as a cellular network in order to implement the various blocks of the flow diagrams.

What is claimed is:

1. A method of maintaining a chain-of-ownership for items, the method comprising:
using an Internet to receive from a cryptocurrency blockchain at least part of a transaction chain for a first originator cryptocurrency address assigned to a first originator, wherein the transaction chain comprises:
a first transfer of cryptocurrency from the first originator cryptocurrency address to a first item cryptocurrency address assigned to a first item;
a second transfer of cryptocurrency from the first item cryptocurrency address to a first transferee cryptocurrency address assigned to a first transferee of the first item;
a third transfer of cryptocurrency from the first originator cryptocurrency address to a second item cryptocurrency address assigned to a second item; and
a fourth transfer of cryptocurrency from the second item cryptocurrency address to a second transferee cryptocurrency address assigned to a second transferee of the second item; and
displaying on a computer screen at least part of the transaction chain associated with at least the first item.

2. The method as recited in claim 1, wherein the cryptocurrency addresses are bitcoin addresses.

3. The method as recited in claim 1, further comprising displaying on the computer screen a link to a webpage of a website associated with the first originator cryptocurrency address, wherein the webpage comprises the first originator cryptocurrency address.

4. A method of maintaining a chain-of-ownership for items, the method comprising:
storing in a chain-of-ownership database a first record which assigns a first item cryptocurrency address to a first item;
using an Internet to transfer cryptocurrency from a first originator cryptocurrency address assigned to a first originator to the first item cryptocurrency address;
storing in the chain-of-ownership database a second record which assigns a second item cryptocurrency address to a second item; and
using the Internet to transfer cryptocurrency from the first originator cryptocurrency address to the second item cryptocurrency address.

5. The method as recited in claim 4, wherein the cryptocurrency addresses are bitcoin addresses.

6. The method as recited in claim 4, further comprising transmitting over the Internet the first originator cryptocurrency address to a chain-of-ownership (COO) website.

7. The method as recited in claim 6, further comprising configuring a website of the first originator to display the first originator cryptocurrency address.

8. A computer configured to:
store a chain-of-ownership (COO) database in a non-transient computer readable storage medium;
store in the COO database a first record comprising a first item cryptocurrency address assigned to a first item; and
store in the COO database a second record comprising a second item cryptocurrency address assigned to a second item;
wherein:
a first transaction chain of the first item cryptocurrency address comprises a transfer of cryptocurrency from a first originator cryptocurrency address to the first item cryptocurrency address as reflected in a cryptocurrency blockchain accessible over an Internet; and
a second transaction chain of the second item cryptocurrency address comprises a transfer of cryptocurrency from the first originator cryptocurrency address to the second item cryptocurrency address as reflected in the cryptocurrency blockchain.

9. The computer as recited in claim 8, wherein the cryptocurrency addresses are bitcoin addresses.

10. The computer as recited in claim 8, wherein the computer is further configured to receive the first originator cryptocurrency address over the Internet.

11. The computer as recited in claim 10, wherein the computer is further configured to receive over the Internet a webpage address of an originator website associated with the first originator cryptocurrency address.

12. The computer as recited in claim 11, wherein the computer is further configured to verify the originator website comprises the first originator cryptocurrency address.

13. The computer as recited in claim 12, wherein the computer is further configured to:
host a COO website configured to access the COO database; and
verify the originator website comprises the first originator cryptocurrency address when a first originator associated with the first originator cryptocurrency address registers with the COO website.

14. The computer as recited in claim 13, wherein the computer is further configured to display an error message in the COO website when the verification fails.

15. The computer as recited in claim 13, wherein when the verification fails the computer is further configured to prevent the first originator from registering with the COO website until the originator website comprises the first originator cryptocurrency address.

16. The computer as recited in claim 11, wherein the computer is further configured to display in a COO website a link to the webpage of the originator website.

17. The computer as recited in claim 16, wherein when a user of the COO website selects the link, the computer is further configured to display the webpage to the user.

18. The computer as recited in claim 16, wherein the webpage of the originator website comprises the first originator cryptocurrency address.

19. The computer as recited in claim 18, wherein when the webpage of the originator website is displayed to the user, the first originator cryptocurrency address is displayed to the user.
